(19) United States
(12) Patent Application Publication
(10) Pub. No.: US 2007/0011232 A1
(43) Pub. Date: Jan. 11, 2007

(54) User interface for starting presentations in a meeting

(75) Inventors: Todd R. Manion, Redmond, WA (US); Sandeep K. Singhal, Kirkland, WA (US); Gursharan Sidhu, Seattle, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/175,863

(22) Filed: Jul. 6, 2005

(51) Int. Cl. G06F 15/16

(52) U.S. Cl. 709/204

(57) ABSTRACT

A drag-and-drop user interface facilitates the selection and presentation of data to meeting participants from one of the peers in a peer-to-peer network. First icons associated with data for presentation may be dragged onto second icons associated with networked resources such as computers associated with meeting participants or other networked resources such as projectors. The data may be streamed from the presenter's computer to the networked resource over peer-to-peer network facilities such as a terminal services session.

### BACKGROUND

Computers have been used in meetings for some time. Computers have been used to take minutes in real time. It is almost common practice now to use a computer and an attached projector when presenting information to a group at a meeting. Several attempts have been made, with varying success, to address meetings with remote participants. Initially, meeting participants would e-mail documents to all expected attendees for presentation during the meeting. Presentations were synchronized by the leader's instructions during a teleconference. Later, products such as Microsoft NetMeeting allowed the use of file distribution during the meeting and interactive tools such as a white board would allow real-time interaction between users. NetMeeting allowed screen sharing of presentation data but required that the file be opened manually outside NetMeeting and then manual identification of the process from within NetMeeting. When multiple files were open in one application, there was room for error in which file was shared. Web-based services, such as LiveMeeting require manual upload of a file to a server before sharing can take place. Often, everyone in attendance at an electronic meeting would receive copies during the meeting. Multiple copies of data were routinely left as artifacts of the meeting and contributed to confusion over versioning. Additionally, the user interface for file sharing was manual and menu-driven.

Drag-and-drop user interaction has been used as a shortcut for certain menu picks, such as, copy, move, and print. However, a drag-and-drop interface has been limited to such file-oriented operations.

### SUMMARY

A user interface for starting presentations in a meeting advantageously combines the familiar drag-and-drop interface with the automatic identification of application programs associated with data files for presentation and peer-to-peer network connectivity techniques. This combination provides a simple and intuitive user interface for starting shared presentations during an on-line meeting. Peer-to-peer networking infrastructure develops and manages the sharing and connectivity required to set up the links with meeting attendees and delivers the appropriate data streams to network resources associated with the attendees.

First icons representing data may be selected and moved onto second icons representing meeting participants or other network resources, such as participant's computers or projectors.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a representation of a computer display showing icons;

FIG. 4 is a block diagram of software modules on a computer-readable medium; and

FIG. 5 is a flow chart of a method for starting presentations in a meeting.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

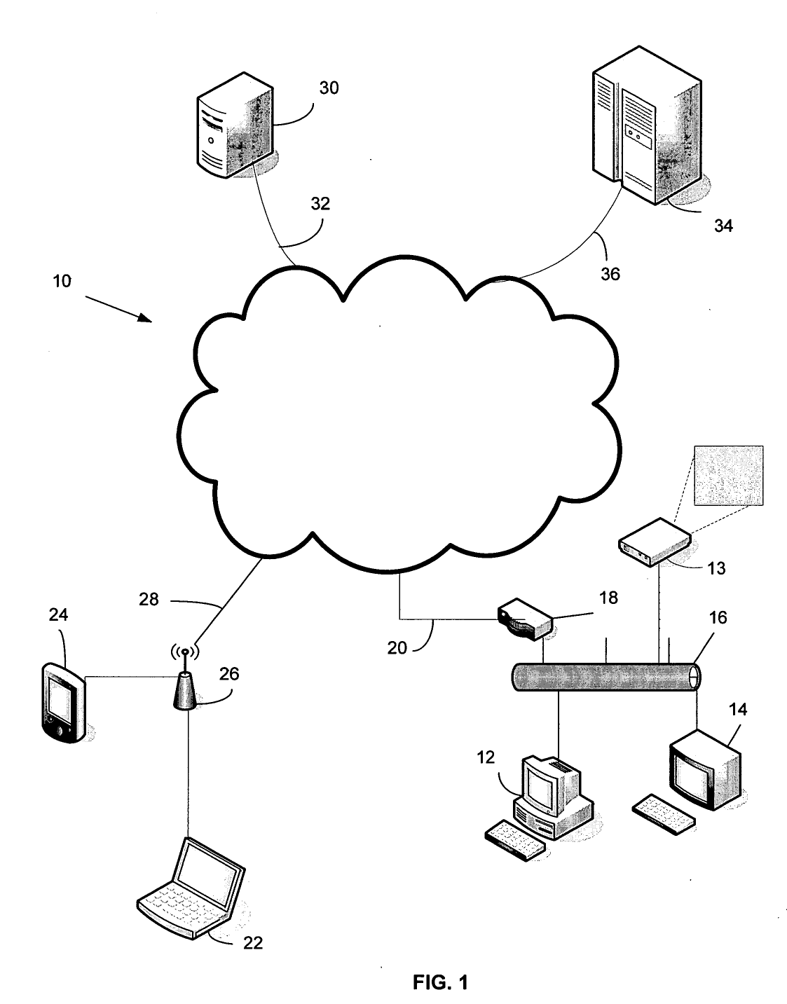

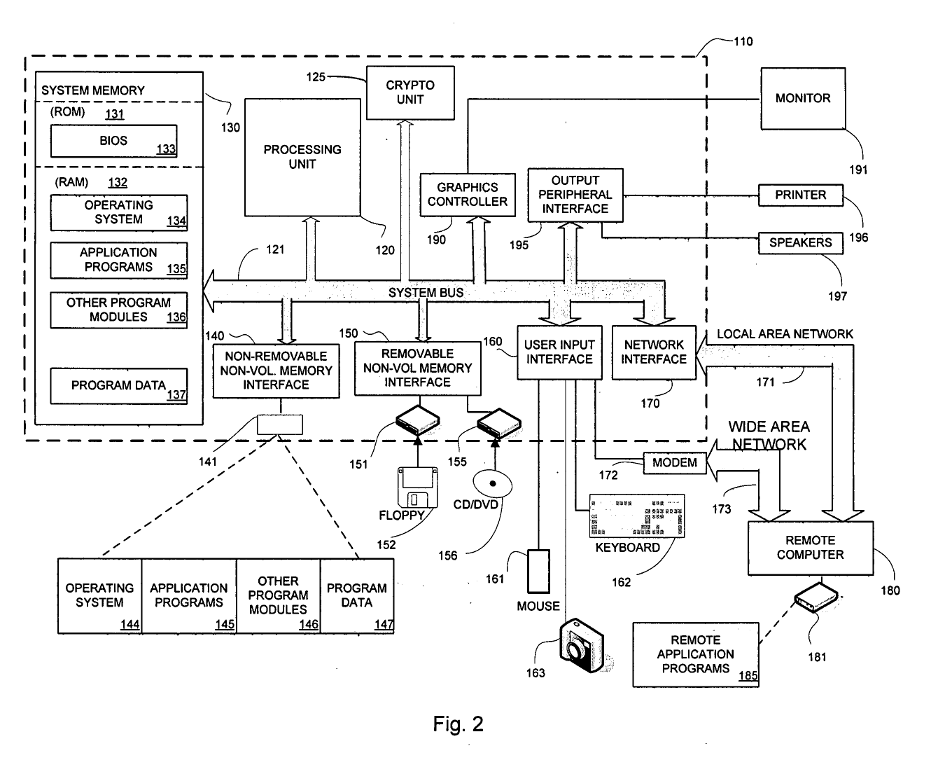

FIGS. 1 and 2 provide a structural basis for the network and computational platforms related to the instant disclosure.

FIG. 1 illustrates a network 10 that may be used to implement a dynamic software provisioning system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. Other networked resources, such as a projector 13, may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. In one embodiment, the server 30 may function as a presentation server for serving presentation data on the network 10. In another embodiment, the mainframe 34 may function as a broadcast server to make available data to a large number of users, for example, corporate financial results presentations. The network 10 may be useful for supporting peer-to-peer network traffic. It should be noted that peer-to-peer network traffic may pass through intermediate hosts, including servers, proxies, routers, switches, and other elements whose role is to facilitate the transmission of data between the communicating hosts.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In addition, the cryptographic unit 125 may include an RNG (random number generator) which is used to provide random numbers. In other embodiments, the functions of the cryptographic unit may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 10 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

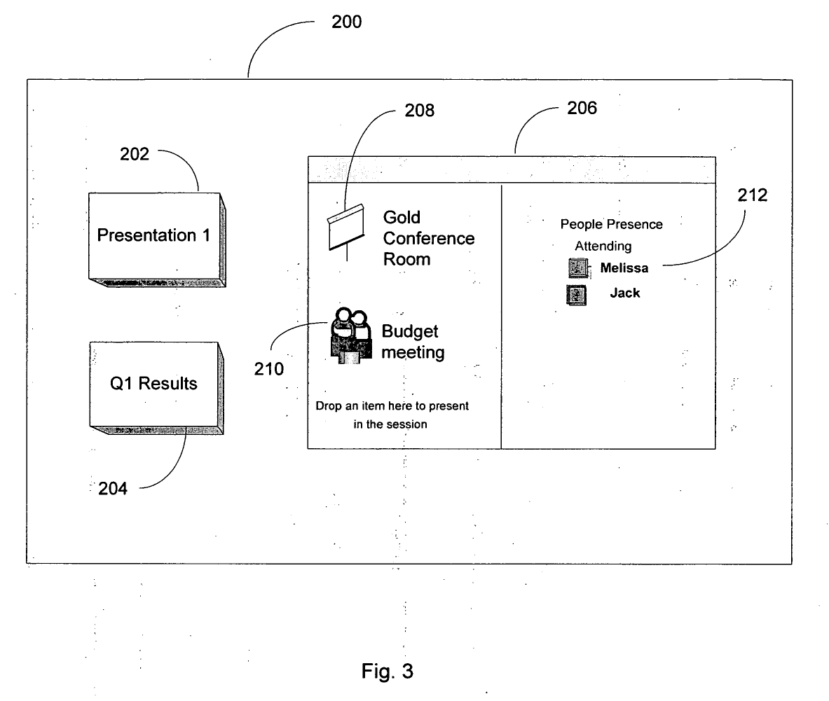

FIG. 3 depicts screen data 200 of a computer, such as may be seen on monitor 191 of computer 110 of FIG. 2. The screen data 200 may include first icons representing data, such as icon 202 titled, “Presentation 1” and icon 204 titled, “Q1 results.” The first icons 202 204 may be associated with a variety of application programs. Such programs may include a word processor, a multimedia player, a presentation manager or a file viewer, for example a portable data format (.pdf) file viewer. The first icons 202 204 may also represent the applications themselves apart from data created with the application. A window 206 associated with a meeting may contain second icons associated with networked resources. Second icon 208 may represent projection equipment in the “Gold” conference room. Second icon 210 may represent all persons presently in attendance at the meeting, for example, an on-line meeting over a peer-to-peer network. A second frame 212 may represent all attendees currently involved in a particular oh-line meeting. In one embodiment, selecting, dragging and dropping one of the first icons, for example, first icon 202 representing a presentation, onto icon 210, representing attendees at the current meeting would cause the presentation to be streamed to the selected attendees. Similarly, first icon 204 labeled “Q1 Results,” may be dragged onto second icon 208 to initiate the presentation of the Q1 Results slides on the projector in the gold conference room. To the local user, that is, the presenter, the effect is similar to opening and viewing the file. An application program associated with the first icon, for example, Microsoft PowerPoint™, may be activated when the data from the file represented by the first icon 200 204 is displayed. As discussed below, meeting attendees will see the presentation file streamed from the presenter, for example, in the left-hand pane of the meeting window 206.

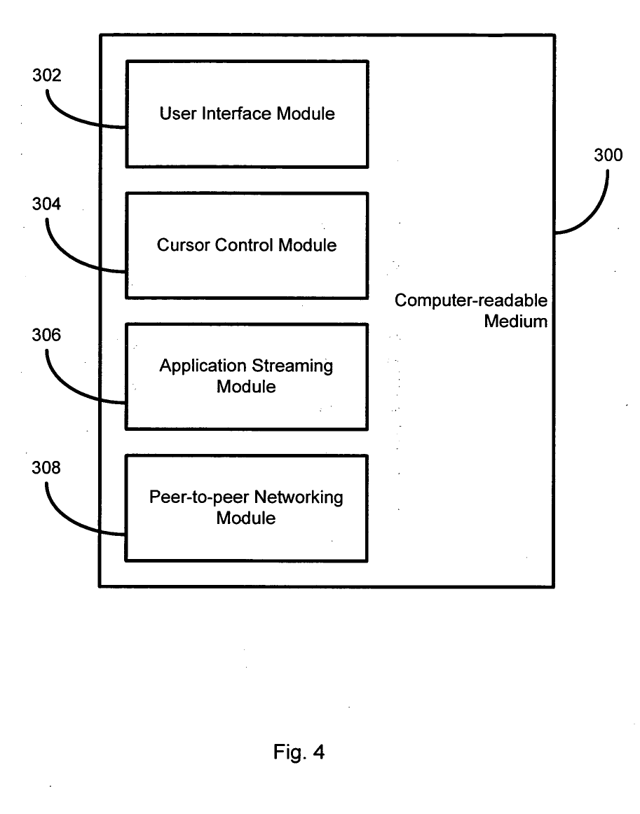

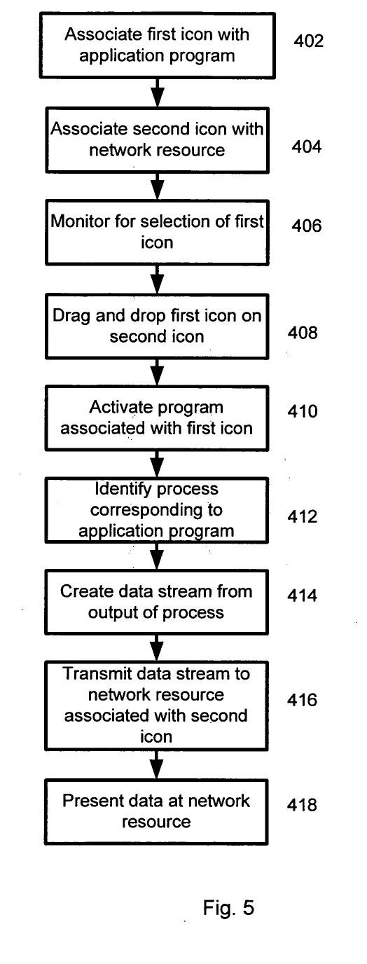

FIG. 4 depicts in block diagram form a representation of computer-executable modules that may be used for presenting a user interface for starting a meeting. A computer-readable medium 300 may be any of the storage media discussed above, including hard disk drives, optical media, flash memory, etc. A user interface module 302 may be used to present data to a user, in particular, an icon-based interface comprising representations of network accessible resources and remote users. A cursor control module 304 may provide a mechanism for a user to control operation of his or her computer via selection, movement and drag-and-drop operations, among other user interface elements. An application streaming module 306 may be activated to determine the identity of a process associated with “dropped” data and establish a data stream associated with that process. A peer-to-peer networking module 308 may be activated to manage the overhead associated with streaming the application data to the various identified networked resources over a peer-to-peer network, for example, network 10 of FIG. 1. The operation of the computer executable modules of FIG. 4 are discussed more fully with respect to FIG. 5.

FIG. 5, a method of starting presentations in a meeting is discussed and described. In a normal manner, a first icon, such as first icon 202 204 may be associated 402 with an application program. One way of doing this is to generate data in an application program and save the file, thus creating an icon associated with the data file in the application program. A second icon 208 210 may be associated 404 with a networked resource, such as computer 110 of FIG. 2, personal computer 12, or laptop computer 22 of FIG. 1. The networked resource may also be a shared asset, such as projector 13 of FIG. 1. The networked resource may also be implicitly associated with the second icon; for example, if the second icon represents one or more users, then the associated networked resource may be the computers used by these one or more users. In one embodiment, the networked resource may be a personal computer or laptop, or tablet used by a meeting participant. In alternative embodiments, the networked resource may be another device, such as a PDA or cell phone.

After a peer-to-peer network meeting has been established, a presenter may wish to show materials to the meeting attendees. The presenter may select one of the first icons. The operating system 134 or a process associated with a meeting window 206 may monitor 406 the selection of the first icon 202 204. The presenter may then move the first icon 202 204 to an appropriate second icon 208 210 and release the first icon 202 204 over the second icon 208 210. This so-called drag-and-drop 408 motion initiates activities associated with presenting the data to the meeting participants, via the network resources (computers 12 22, projector 13, etc.) associated with the second icon.

In a fashion similar to opening a file for local viewing, the drag-and-drop motion may require the application program associated with the first icon to be started 410. If the application is already running, the program may not need to be started. In either case, when the application program is running, the process associated with the application may be identified 412. Data output from the identified process may be monitored and used to create 414 a data stream. Using standard peer-to-peer networking techniques, for example, a terminal services session, the data stream may be transmitted 416 to the various network resources previously identified. A meeting window, similar to or the same as window 206 on the networked resource 210 may be used to render or otherwise output 418 the data stream. In one embodiment, the data stream includes graphical data interface (GDI) information.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1. A computer-readable medium having computer-executable modules for execution on a computer comprising:
a user interface module for displaying first and second icons, each of the first icons associated with application data, each of the second icons associated with a corresponding networked resource;
a cursor control module for selecting and moving at least one of the first icons;
an application streaming module for creating streaming data corresponding to at least one of the first icons; and
a peer-to-peer network module for directing the streaming data to the networked resource associated with one of the second icons, wherein the cursor control module is used to select at least one of the first icons and move it to at least one of the second icons, thereby activating the application module to create streaming data corresponding to the selected first icon and activating the peer-to-peer network module to direct the streaming data to the network resource associated with the at least one of the second icons.

2. The computer-readable medium of claim 1, wherein the first icons represent data associated with at least one application program and the application streaming module monitors a process identifier associated with the at least one application program corresponding to the selected at least one of the first icons.

3. The computer-readable medium of claim 2, wherein the application streaming module is a terminal services session and the streaming data comprises graphical data interface (GDI) information output from the at least one application program.

4. The computer-readable medium of claim 2, wherein the at least one application program is one of a word processor, a multimedia player, a presentation manager, a personal digital assistant, a cellular telephone, and a portable data format file viewer.

5. The computer-readable medium of claim 1, wherein the networked resource is one of a computer, a workstation, a presentation server, and a broadcast server.

6. The computer-readable medium of claim 1, wherein the networked resource is a storage media for making an archival copy of the data stream.

7. The computer-readable medium of claim 1, wherein the networked resource is a projector.

8. In a computer system having a graphical user interface including a display and a user interface selection device, a method for activating a peer-to-peer network session comprising:
presenting data from the computer system to a networked resource, the computer system presenting a first icon corresponding to the data and a second icon corresponding to the networked resource;
monitoring selection of the first icon;
monitoring dragging and dropping of the selected first icon onto the second icon;
activating an application program associated with the selected first icon responsive to selection of the first icon and subsequent dragging and dropping of the selected first icon onto the second icon;
identifying a process corresponding to the application program;
creating a data stream comprising output from the process; and
transmitting the data stream to the networked resource associated with the second icon.

9. The method of claim 8, wherein transmitting the data stream further comprises transmitting the data stream via a peer-to-peer network.

10. The method of claim 8, wherein the networked resource is a remote computer.

11. The method of claim 10 further comprising:
receiving the data stream at the remote computer; and
outputting a representation of the data stream.

12. The method of claim 8, wherein the networked resource is a projector.

13. The method of claim 12 further comprising:
receiving the data stream at the projector; and
displaying a representation of the data stream.

14. The method of claim 8, further comprising receiving the data stream at the networked resource.

15. The method of claim 14, wherein the networked resource is at least one of a workstation, a presentation server, a broadcast server, or a storage media.

16. A computer adapted for sharing data between the computer and a remote resource comprising:
a display and display controller adapted for presentation of a plurality of first icons, each of the plurality of first icons associated with data and a plurality of second icons associated with networked resources;
a network adapter for transmitting data over a peer-to-peer network; and
a processor programmed for:
receiving input from a cursor control device;
determining when at least one of the plurality of first icons is dragged and dropped on at least one of the plurality of second icons;
activating at least one application program associated with the at least one of the plurality of first icons;
directing a data stream associated with the data and the application program via the network adapter to a peer-to-peer network for display at a networked resource associated with the at least one of the plurality of second icons.

17. The computer of claim 16, the processor further programmed for identifying a process associated with the at least one application program.

18. The computer of claim 17, the processor further programmed for creating the data stream from data generated by the process.

19. The computer of claim 18, the processor further programmed for creating a terminal service for directing the data stream associated with the data and the application program via the network adapter to the peer-to-peer network.

20. The computer of claim 16, wherein the data associated with at least one of the plurality of first icons is at least one of graphics data, chart data, presentation data,
video data, sound data, picture data, or text data.
